(19) United States
(12) Patent Application Publication
(10) Pub. No.: US 2011/0200119 A1
(43) Pub. Date: Aug. 18, 2011

(54) INFORMATION PROCESSING APPARATUS AND METHOD FOR REPRODUCING VIDEO IMAGE

(75) Inventor: Yuichiro ASO, Hamura-shi (JP)

(73) Assignee: KABUSHIKI KAISHA TOSHIBA, Tokyo (JP)

(21) Appl. No.: 13/098,347

(22) Filed: Apr. 29, 2011

Related U.S. Application Data
(63) Continuation of application No. 12/423,631, filed on Apr. 14, 2009.

(30) Foreign Application Priority Data
Jun. 13, 2008 (JP) 2008-155154

(51) Int. Cl. H04N 11/02

(52) U.S. Cl. 375/240.25; 375/E07.027

(57) ABSTRACT

An information processing apparatus includes: a stream data separating module configured to separate compressed video data and compressed sub-picture data from compressed stream data; a memory configured to store the compressed video data and the compressed sub-picture data; a first conversion processing module configured to up-convert the compressed video data being read out from the memory and decoded into converted video data containing high definition video image; a second conversion processing module configured to up-convert the compressed sub-picture data being read out from the memory and decoded into converted sub-picture data containing high definition sub-picture image; and a rendering module configured to combine the converted video data with the converted sub-picture data to generate combined data.

### CROSS-REFERENCE TO RELATED APPLICATIONS

This is a continuation of U.S. patent application Ser. No. 12/423,631 filed on Apr. 14, 2009, which is based upon and claims the benefit of priority from Japanese Patent Application No. 2008-155154 filed on Jun. 13, 2008, the entire contents of both, which are incorporated herein by reference.

### BACKGROUND OF THE INVENTION

1. Field of the Invention

The present invention relates to an information processing apparatus and a method for reproducing video image.

2. Description of the Related Art

In accordance with recent capability of handling multimedia data in a computer, a computer provided with a DVD (Digital Versatile Disc) drive for reproducing a DVD is being widely used. A single DVD-ROM medium can record 4.7 G bytes of data on one side which are about seven times as large as that of a conventional CD-ROM. In a double-sided DVD-ROM, 9.4 G bytes of data are recordable. When a DVD-ROM medium is used, high-quality reproduction of moving pictures such as a movie including a large quantity of image information can be performed on a computer.

The data structure of video information recorded on a DVD-ROM medium is defined by the DVD video standard. Video information can be roughly classified into two types of data, which are presentation data and navigation data.

The presentation data are a set of video objects to be reproduced, and configured by video, sub-picture, and audio data. The video data are compressed and encoded by the MPEG-2 system. The sub-picture data are bit map data used for displaying captions of a movie, options on a menu screen, and the like. In one video object, video data of one channel, audio data of 8 channels at the maximum, and sub-picture data of 32 channels at the maximum can be included.

In recent years, along with the development in digital compression/encoding technique of moving pictures, reproducing apparatuses (video players) which can handle high definition images of the HD (High Definition) standard have become widely used. In these days, software development for enabling a personal computer to handle such a high definition images of the HD standard is advanced. An example of such system is disclosed in JP-A-2008-040826 (counterpart U.S. publication is: US 2008/0034330 A1).

In an information processing apparatus disclosed in the publication JP-A-2008-040826, two cursors are simultaneously displayed on a screen of a display device when contents for which cursors are respectively defined are reproduced under the multi-window environment and both cursors are appropriately operated in accordance with an operation input through a pointing device.

In a conventional information processing apparatus, however, various types of multiple internal processing are performed as background process also during the reproduction of a DVD. When reproducing a DVD, a processor load is increased as compared with the processor load in a normal state where the DVD is not reproduced. When an image of the SD (Standard Definition) standard is converted into a high-definition image of the HD standard and reproduced, and then the display of captions and the menu operation are performed, and the processor load is further increased. In some cases, therefore, there occur problems such as that, depending on circumstances, the reproduction of the moving pictures is interrupted and becomes clumsy.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view showing an information processing apparatus according to an embodiment of the invention.

FIG. 2 is a block diagram showing a system configuration of the information processing apparatus.

FIG. 3 is a diagram illustrating a flow of data in DVD reproduction.

FIG. 4 is a diagram showing a reproduction processing in the case where a DVD is reproduced by the information processing apparatus.

FIG. 5 is a flowchart showing the flow of the reproduction processing in the case where a DVD is reproduced by the information processing apparatus.

### DETAILED DESCRIPTION OF THE PREFERRED EMBODIMENT

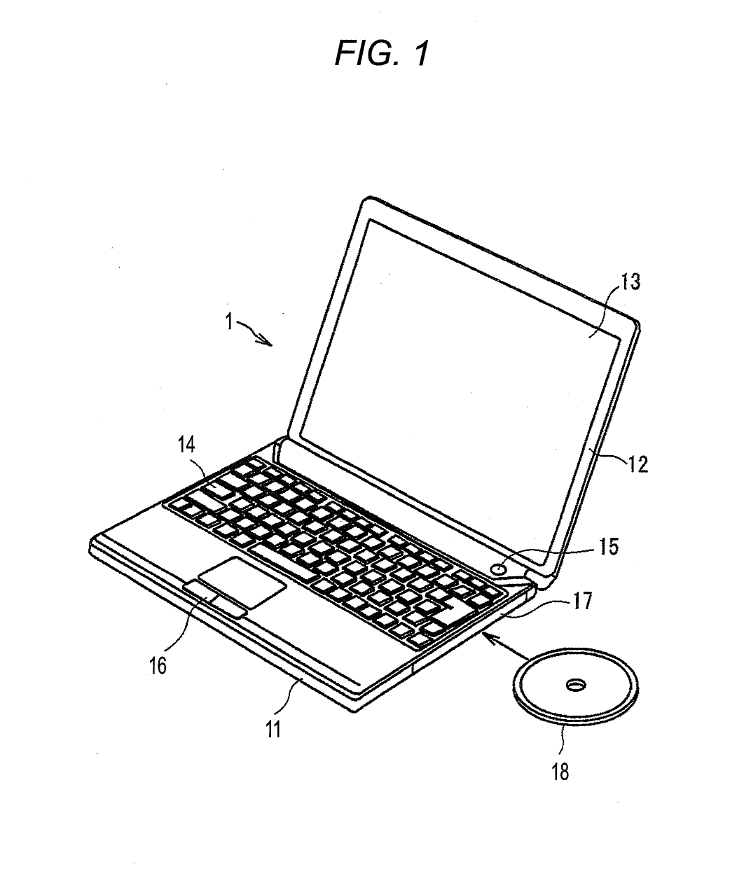

An embodiment of the invention will be described below with reference to the drawings. FIG. 1 is a perspective view showing an information processing apparatus according to an embodiment of the invention.

The information processing apparatus 1 is a notebook personal computer, and configured by a main unit 11, and a display unit 12. A display device such as an LCD (Liquid Crystal Display) panel 13 is provided in the display unit 12.

The display unit 12 is attached to the main unit 11 so as to be swingable between an opened position and a closed position. The main unit 11 has a case having a thin box shape. On the upper face of the main unit, a keyboard 14, a power switch 15 for turning on/off the power of the information processing apparatus 1, and a touch pad 16 are arranged.

A DVD drive 17 serving as an optical media drive is disposed on a side face of the main unit 11. The DVD drive 17 is capable to perform recording data onto a recording medium such as a CD (Compact Disc) and a DVD 18, and to perform reading the data recorded on the recording medium.

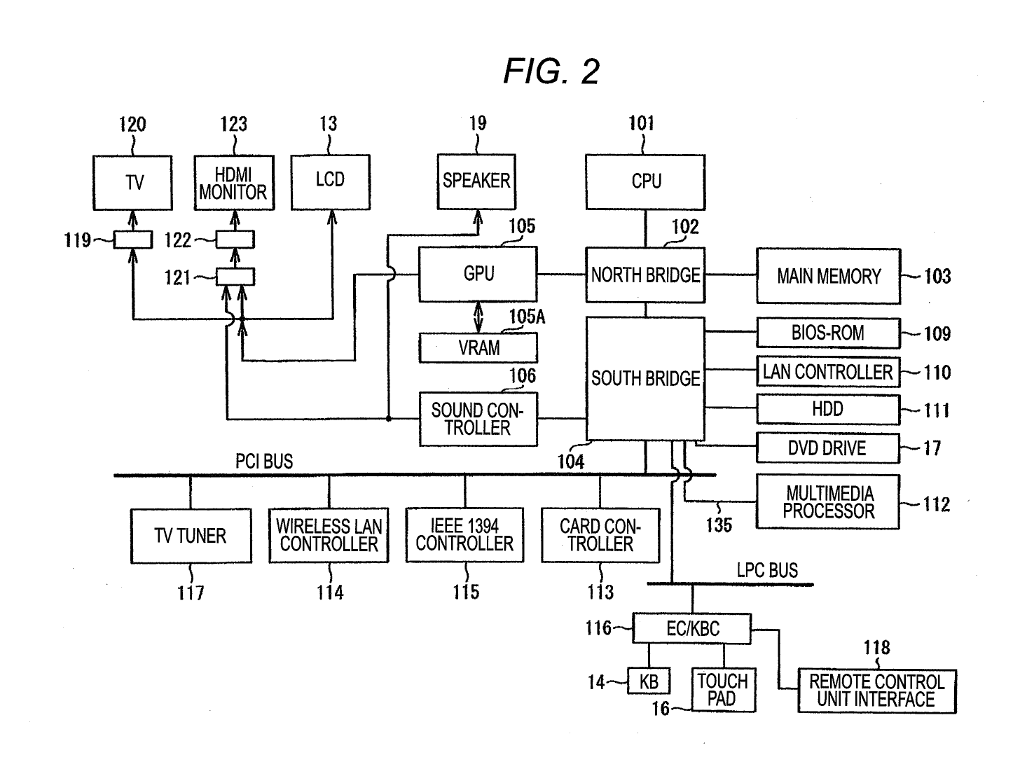

FIG. 2 is a block diagram showing the system configuration of the information processing apparatus 1.

As shown in FIG. 2, the information processing apparatus 1 includes a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard-disk drive (HDD) 111, a DVD drive 17, a multimedia processor 112, a card controller 113, a wireless LAN controller 114, an IEEE 1394 controller 115, an embedded controller/keyboard controller IC (EC/KBC) 116, a TV tuner 117, and a remote controller unit interface 118.

The CPU 101 is a processor which serves as a main controller for controlling the operation of the information processing apparatus 1. The CPU 101 runs an operating system (OS) and various application programs such as a DVD application program which are loaded from the hard-disk drive (HDD) 111 to the main memory 103. The DVD application program is software for performing recording/reproducing functions for the DVD. The CPU 101 executes a BIOS (Basic Input Output System) stored in the BIOS-ROM 109. The BIOS is a program for controlling the hardware.

The north bridge 102 is a bridge device which connects a local bus of the CPU 101 to the south bridge 104. In the north bridge 102, also a memory controller which controls the access to the main memory 103 is incorporated. The north bridge 102 has also a function of performing communication with the GPU 105 via a serial bus of the PCI Express standard or the like.

The GPU 105 is a display controller which controls the LCD panel 13 used as a display monitor of the information processing apparatus 1. The CPU 105 is configured to perform image processing on video data and output digital video signal. A display signal produced by the GPU 105 is supplied to the LCD panel 13. The GPU 105 can transmit a digital image signal to an external television apparatus (TV) 120 via a TV terminal 119, and further transmit a digital image signal to an HDMI monitor 123 via an HDMI control circuit 121 and an HDMI terminal 122.

The south bridge 104 controls devices on an LPC (Low Pin Count) bus, and those on a PCI (Peripheral Component Interconnect) bus. In the south bridge 104, an IDE (Integrated Drive Electronics) controller which controls the hard-disk drive (HDD) 111 and the DVD drive 17 is incorporated. In addition, the south bridge 104 has a function of performing communication with the sound controller 106.

The multimedia processor 112 is connected to the south bridge 104 via a PCI Express bus 135 which is a serial bus of the PCI Express standard.

The multimedia processor 112 is a processor which serves as a first conversion processing module for up-converting video data included in compressed stream data as DVD reproduction data based on the reproduction of a DVD by the DVD drive 17 serving as the data reading module, to data (HD-quality data) of the HD (High Definition) standard as converted video data.

In the embodiment, when the up-converting function is selected in reproduction of a DVD on which image contents such as a movie are recorded, compressed stream data which are obtained by multiplexing video data (main image data) encoded by the MPEG (Moving Picture Experts Group) 2 system, audio data, and sub-picture data (sub-image data) such as caption data are read out from the DVD as DVD reproduction data by the DVD application program. For example, the resolution of the compressed stream data is 720×480 or 720×576. The video data included in the compressed stream data read out from the DVD are transferred to the multimedia processor 112 via the PCI Express bus 135 which has a high transfer speed, and then subjected to processes of decoding and up-converting to HD-quality video data with the resolution of, for example, 1,920×1,080. Thereafter, the obtained data are combined with the sub-picture data which have undergone the up-conversion processing separately from the video data, and then subjected to the rendering processing.

In the embodiment, the multimedia processor 112 serving as a dedicated processor which is different from the CPU 101 is used as a back-end processor. The multimedia processor 112 performs the decoding processing of the compressed stream data and the up-conversion processing of the video data. Accordingly, the up-conversion processing can be performed without increasing the processor load on the CPU 101.

The sound controller 106 is a sound source device, and outputs audio data to be reproduced to a speaker 19 or the HDMI control circuit 121.

The card controller 113 controls accessing a multimedia card such as a PC card or an SD (Secure Digital) card. The wireless LAN controller 114 is a wireless communication device which performs wireless communication of the IEEE 802.11 standard or the like. The IEEE 1394 controller 115 performs communication with an external device via a serial bus of the IEEE 1394 standard.

The embedded controller/keyboard controller IC (EC/KBC) 116 is a one-chip microcomputer in which an embedded controller for managing the power, and a keyboard controller for controlling the keyboard (KB) 14 and the touch pad 16 are integrated. The embedded controller/keyboard controller IC (EC/KBC) 116 has a function of powering on/off the information processing apparatus 1 in response to an operation input through the power switch 15 by the user. In addition, the embedded controller/keyboard controller IC (EC/KBC) 116 has a function of performing communication with the remote control unit interface 118.

The TV tuner 117 is a receiver which receives broadcast program data broadcasted on a television broadcasting signal. For example, the TV tuner is implemented as a digital TV tuner which is capable to receive digital broadcast program data such as terrestrial digital TV broadcast.

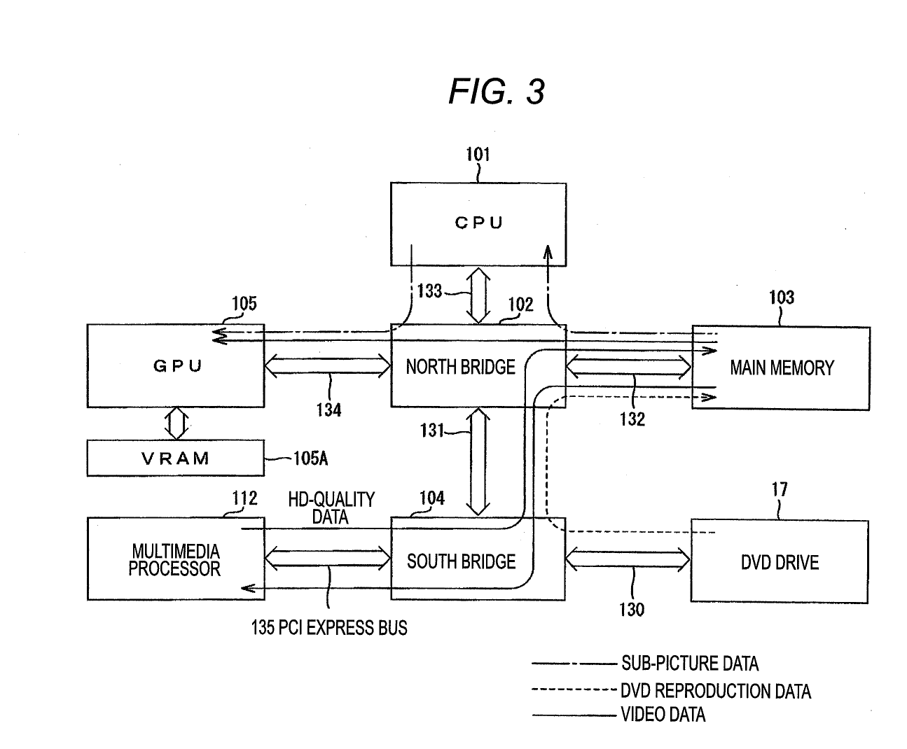

FIG. 3 is a diagram illustrating the flow of data in DVD reproduction.

The DVD reproduction data based on reproduction of a DVD are compressed stream data including video data, audio data, and sub-picture data such as caption data. In the following description, the flow of the video data and the sub-picture data in the case where the compressed stream data read out from the DVD are to be output as HD-quality data will be described.

The compressed stream data are transferred to the main memory 103 via the PCI bus 130, the south bridge 104, the DMI (Direct Media Interface) bus 131, the north bridge 102, and the data bus 132.

The video data included in the compressed stream data transferred to the main memory 103 are read out from the main memory 103 based on the execution of the DVD application program, and then transferred to the multimedia processor 112 via the data bus 132, the north bridge 102, the DMI bus 131, the south bridge 104, and the PCI Express bus 135.

The compressed stream data transferred to the multimedia processor 112 are subjected to the MPEG2 decoding processing and the up-conversion processing, and then, as HD-quality data, transferred again to the main memory 103 via the PCI Express bus 135, the south bridge 104, the DMI bus 131, the north bridge 102, and the data bus 132.

The video data which are the up-converted HD-quality data transferred to the main memory 103 are read out again from the main memory 103 based on the execution of the DVD application program, and then transferred to the GPU 105 via the data bus 132, the north bridge 102, and the data bus 134. Thereafter, the data are transferred from the GPU 105 to the VRAM 105A.

The sub-picture data included in the compressed stream data transferred to the main memory 103 are read out from the main memory 103 based on the execution of the DVD application program, and transferred to the CPU 101 via the data bus 132, the north bridge 102, and an FSB (Front Side Bus) 133. The sub-picture data are subjected to the up-conversion processing according to the HD standard in the CPU 101, and then transferred to the GPU 105 via the FSB 133, the north bridge 102, and the data bus 132. Thereafter, the data are transferred from the GPU 105 to the VRAM 105A. Alternatively, the up-conversion processing of the sub-picture data may be performed in the GPU 105. In accordance with the operational status of the information processing apparatus 1, the up-conversion processing is performed in the CPU 101 or in the GPU 105.

The video data and sub-picture data transferred to the VRAM 105A are combined with each other for each frame, and then transferred to the GPU 105 in which the combined data undergo the rendering processing. The video data and the sub-picture data may be combined with each other in the CPU 101 or in the GPU 105.

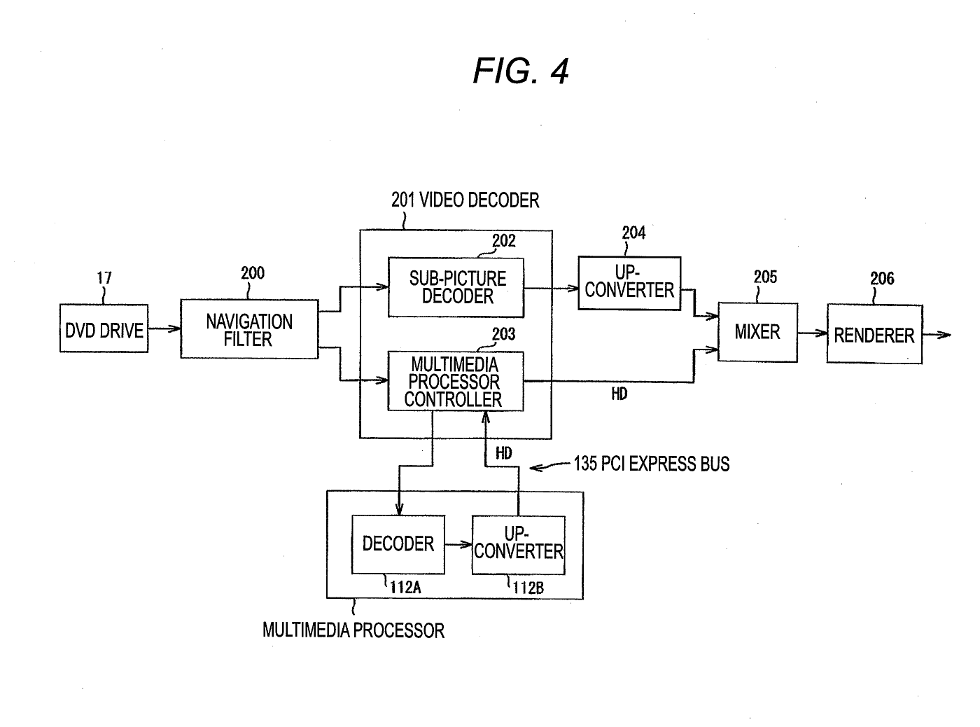

FIG. 4 is a diagram showing the reproduction processing in the case where a DVD is reproduced by the information processing apparatus of the embodiment of the invention.

The reproduction of the DVD is performed by the DVD application program loaded in the main memory 103 of the information processing apparatus 1. The DVD application program includes: a navigation filter 200 which functions as a stream data separating module that separates the compressed stream data, and which controls the transfer of the separated compressed stream data; and a video decoder 201 having a sub-picture decoder 202 which decodes the compressed sub-picture data included in the compressed stream data, and a multimedia processor controller 203 which controls the transfer of the compressed video data to the multimedia processor 112.

The navigation filter 200 separates the compressed video data and compressed sub-picture data included in the compressed stream data, and outputs the separated data to the video decoder 201.

The video decoder 201 is provided with: the sub-picture decoder 202 which decodes the compressed sub-picture data transmitted from the navigation filter 200; and the multimedia processor controller 203 which transmits the compressed video data transmitted from the navigation filter 200, to the multimedia processor 112 in the case where the up-conversion processing is specified.

The multimedia processor 112 is provided with: a decoder 112A which decodes the compressed video data transmitted from the multimedia processor controller 203; and an up-converter 112B which performs the up-conversion processing on the decoded base-band video data.

The multimedia processor controller 203 includes a decoder for video data, and has a function of, in the case where the up-conversion processing is not specified, converting the compressed video data to base-band SD data.

The base-band sub-picture data output from the video decoder 201 are transmitted to the mixer 205 via an up-converter 204 which is disposed in a subsequent stage. The base-band video data are transmitted from the multimedia processor controller 203 to the mixer 205.

The up-converter 204 is a second conversion processing module which performs a process of up-converting the sub-picture data such as captions decoded in the sub-picture decoder 202, to converted sub-picture data.

The mixer 205 combines the up-converted video data with the up-converted sub-picture data.

A renderer (rendering module) 206 performs an image-quality improving processing on the image data in which the video data and the sub-picture data are combined with each other, and also a rendering processing on an image to be displayed. In the embodiment, it is assumed that the image-quality improving processing includes a processing such as color adjustment of the combined image data.

Hereinafter, the operation of reproducing a DVD in the information processing apparatus of the invention will be described with reference to the accompanying drawings. In the following description, the case where the DVD reproduction is performed while the up-conversion processing is enabled will be described.

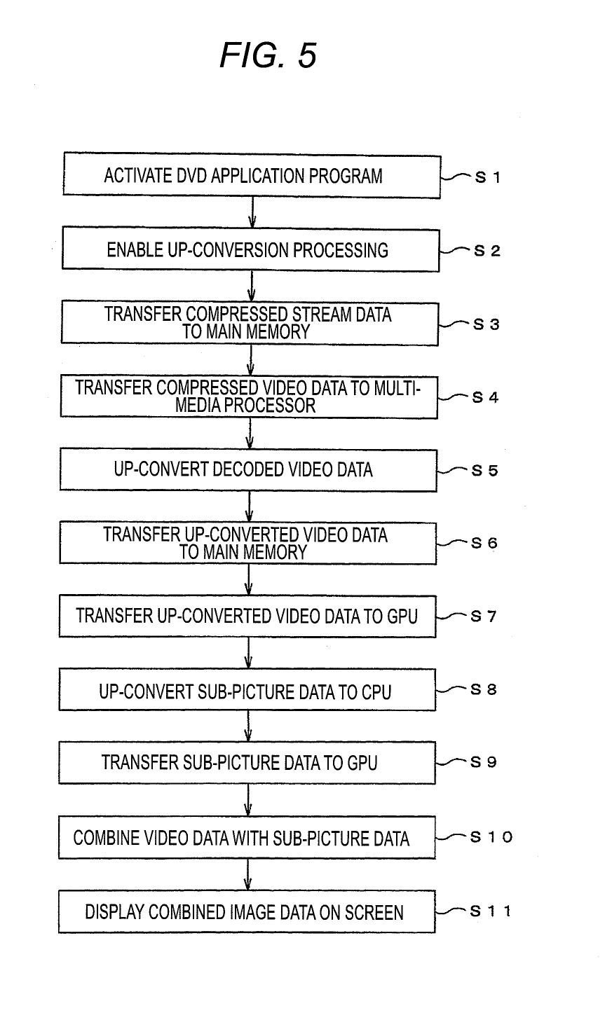

FIG. 5 is a flowchart showing the flow of the reproduction processing in the case where a DVD is reproduced by the information processing apparatus 1.

First, in the condition where the operating system (OS) of the information processing apparatus 1 is activated, the user operates the keyboard 14 and the touch pad 16 to activate the DVD application program (S1).

Next, a DVD 18 on which image contents such as a movie are recorded is set into the DVD drive 17 of the information processing apparatus 1, and the up-conversion processing is enabled while viewing the screen display of the DVD application program displayed on the LCD panel 13 of the display unit 12 (S2).

The CPU 101 transfers the compressed stream data reproduced in the DVD drive 17 to the main memory 103 via the PCI bus 130, the south bridge 104, the DMI bus 131, the north bridge 102, and the data bus 132 (S3).

The compressed stream data transferred to the main memory 103 are subjected to the decryption processing by the DVD application program loaded in the main memory 103, and then separated into the compressed video data and the compressed sub-picture data by the navigation filter 200. These data are output to the video decoder 201.

The compressed video data are transmitted to the multimedia processor controller 203 of the video decoder 201. The compressed video data are read out from the main memory 103 in synchronization with the reproducing operation of the DVD, and transferred to the multimedia processor 112 via the data bus 132, the north bridge 102, the DMI bus 131, the south bridge 104, and the PCI Express bus 135 (S4).

In the multimedia processor 112, the compressed video data are decoded to base-band video data by the decoder 112A, and the decoded video data are up-converted to HD-quality data of high definition by the up-converter 112B (S5).

The up-converted HD-quality data of high definition are transferred again to the multimedia processor controller 203 of the DVD application program loaded in the main memory 103, via the PCI Express bus 135, the south bridge 104, the DMI bus 131, the north bridge 102, and the data bus 132 (S6).

The DVD application program transfers the up-converted video data to the GPU 105. The GPU 105 transfers the video data to the VRAM 105A (S7).

The DVD application program transfers the sub-picture data to the CPU 101 (S8).

The CPU 101 up-converts the sub-picture data, and transfers the up-converted sub-picture data to the GPU 105 (S9).

The GPU 105 transfers the transferred sub-picture data to the VRAM 105A. The GPU 105 combines the video data and sub-picture data of the HD quality which are temporarily stored in the VRAM 105A, by means of the mixer 205, and transfers the combined data to the renderer 206 serving as a rendering module (S10).

The renderer 206 performs the rendering processing on the image data obtained by combining the video data with the sub-picture data, and outputs the image data to a display driver. The display driver drives the LCD panel 13 so as to display the image data on the screen (S11).

According to the above-described embodiment of the invention, the conversion processings such as the decoding and up-conversion of the video data are performed by the multimedia processor 112 connected via a high-speed transmitting path such as the PCI Express bus, and the converted video data are transferred to the subsequent processing circuit via the high-speed transmitting path. Therefore, the decoding processing, and the processing of up-converting to HD-quality data which requires a lot of processing time because of a large computational complexity can be efficiently performed separately from the sub-picture data. Even in the case where the high-quality moving pictures of the HD standards are reproduced while reproducing a DVD, therefore, a high-speed and stable data conversion processing with the real-time property can be performed without causing the reproducing operation to be interrupted.

Particularly, the base-band data contain a larger amount of information as compared with encoded data of the bit stream signal format, and moving pictures of the HD standard which are high-quality moving pictures contain a further larger amount of information. When the processing of up-converting the data and the sub-picture data of the video data is performed in the multimedia processor 112, and these data are combined with each other in the CPU 101 or the GPU 105, the HD-quality base-band data flow on the bus as two streams. Therefore, the flow of two streams reduces the bandwidth, and may cause the reproduction to be delayed. In the embodiment, consequently, the sub-picture data are up-converted in the CPU 101 or the GPU 105 (by the up-converter 204), and the HD-quality base-band data flowing on the bus are restricted to only the video data which are up-converted by the multimedia processor 112. According to the configuration, the amount of information flowing on the bus is suppressed, whereby the real-time property can be ensured.

In the embodiment, in addition to the up-conversion processing, also the decoding processing is performed in the multimedia processor 112. Accordingly, as compared with the case where the decoding processing is performed in the CPU 101 or the GPU 105 and only the up-conversion processing is performed in the multimedia processor 112, the amount of information flowing on the bus 131 can be suppressed, thereby ensuring the real-time property.

With respect to the screen display of captions and the like displayed as sub-pictures, moreover, ON/OFF switching or display switching between captions in Japanese and those in another language may frequently occur during the reproduction. Therefore, the configuration where the sub-picture data are decoded in the CPU 101 or GPU 105 instead of the multimedia processor 112 can flexibly respond to the user needs.

In the case where the video data are converted to HD-quality data of high definition, the information processing load of the conversion processing module is drastically increased. In the information processing apparatus 1 of the above-described embodiment, however, the conversion processing of the sub-picture data is not performed in the multimedia processor 112, so that the multimedia processor 112 can be used especially for the conversion for high definition. Accordingly, the real-time property in synchronization with the image reproduction based on the DVD reproduction can be ensured, and, in the processing for higher resolution, the algorithm with a larger computational complexity can be selected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a stream data separator configured to separate compressed standard definition video data and compressed standard definition sub-picture data from compressed stream data read out from a recording medium;
a memory configured to store the compressed video data and the compressed sub-picture data;
a first converter connected via a bus to a main controller configured to control reproduction of the recording medium, and configured to up-convert the data obtained by decoding the compressed standard definition video data transmitted from the memory into high definition video data, thereby generating converted video data;
a second converter which is a hardware different from the first converter configured to up-convert data obtained by decoding the compressed standard definition sub-picture data transmitted from the memory into high definition sub-picture data, thereby generating converted sub-picture data; and
a rendering module configured to combine the up-converted video data with the up-converted sub-picture data and to output the combined data to a display.

2. The apparatus of claim 1, wherein the first converter comprises a decoder configured to decode the compressed video data.

3. The apparatus of claim 1, wherein the first converter is configured to receive the compressed video data of a bit stream signal format via the bus and to transmit the up-converted video data of a base-band signal format obtained by decoding and upconverting the compressed video data via the bus.

4. The apparatus of claim 1, wherein the second converter is either the main controller or a graphics processing unit.

5. A method for reproducing a video image, the method comprising:
separating compressed video data having a resolution that is lower than that of the High-Definition standard, and compressed sub-picture data from compressed stream data having a resolution lower than that of the High-Definition standard read out from a recording medium;
storing the compressed video data and the compressed sub-picture data;
up-converting data obtained by decoding the compressed video data transmitted from the memory into High-Definition standard video data thereby generating converted video data while being connected to a main controller configured to control reproduction of the recording medium via a bus;
up-converting data obtained by decoding the compressed sub-picture data transmitted from the memory into High-Definition standard data by a hardware different from a hardware that generates the converted video, thereby generating converted sub-picture data; and
combining the up-converted video data with the up-converted sub-picture data into combined data and outputting the combined data to a display.

6. The method of claim 5, wherein, in generating the up-converted video data, the compressed video data of a bit stream signal format are received via the bus; and the up-converted video data of a base-band signal format obtained by decoding and upconverting the compressed video data are transmitted via the bus.

7. An information processing apparatus comprising:
a reader configured to read out stream data in which main image data having Standard Definition resolution and sub-image data having Standard Definition resolution are multiplexed from a storage medium;
a separator configured to separate the main image data and the sub-image data from the stream data read out from the storage medium;
a first up-converter configured to perform high-resolution processing of a sub-image obtained by decoding the sub-image data on a CPU or a GPU;
a second up-converter configured to perform high-resolution processing of a main image obtained by decoding the main image data on a processor connected to the CPU via a bus; and
a rendering module configured to combine the high resolution sub-image processed in the first converter with the high resolution main image processed in the second converter on the CPU or the GPU, and to output the combined image to a display.

8. The apparatus of claim 7, wherein the main image data separated by the separator are transmitted to the processor via the bus, and the processor is configured to perform decoding of the main imaged data and high-resolution processing of the main image obtained by the decoding.
